(19) United States
(12) Patent Application Publication
(10) Pub. No.: US 2019/0166799 A1
(43) Pub. Date: Jun. 6, 2019

(54) PET DISTRACTION DEVICE SYSTEM AND METHOD OF USE

(71) Applicants: Douglas P. Werber, Edgewater, MD (US); Laura Elizabeth Werber, Edgewater, MD (US)

(72) Inventors: Douglas P. Werber, Edgewater, MD (US); Laura Elizabeth Werber, Edgewater, MD (US)

(21) Appl. No.: 16/164,360

(22) Filed: Oct. 18, 2018

Related U.S. Application Data
(60) Provisional application No. 62/593,954, filed on Dec. 3, 2017.

(51) Int. Cl. A01K 15/02; A01K 13/00

(52) U.S. Cl. CPC A01K 15/026; A01K 13/001

(57) ABSTRACT

A pet distraction device having a front surface, a plurality of indentations located on the front surface, a plurality of raised contour grooves located inside the indentations, a back surface, and a plurality of suction cups attached to the back surface with the front surface, back surface, and indentations forming a design shape.

### BACKGROUND

### 1. Field of the Invention

The present invention relates generally to a dog distraction device system and methods of use. More specifically, the invention is related to a system and method to use a treat and toy combination to distract a pet while the owner is taking care of grooming or other pet maintenance.

### 2. Description of Related Art

Systems and methods for pet toys and distraction devices is well known in the art. There are millions of pet dog owners in countries all over the world. Caring for an animal such a dog is much like caring for a child. They have needs for their health, happiness and welfare. These needs include food, exercise, washing, grooming and medical treatments. Pet toys are used to help with this care and distraction methods are employed to keep dogs entertained or distracted during times when the pet must remain still such as during flea treatments or bathing.

One of the problems commonly associated with conventional methods for care is the limited use. The problem that arises is that pets, especially dogs, are often not aware that these activities are good for their health. Dogs can find certain activities boring or uncomfortable and will resist them. Dogs are generally energetic, strong and restless. The energetic nature of a dog makes it difficult to carry out some of these basic tasks. For example, when washing a dog, most owners will put them in the bathtub and wash them with the shower head or faucet. However, it is rare that a dog will sit for ten minutes while the owner washes them. It is more common that the dog will jump out of the bath and create a mess. The traditional method for keeping the dog still is physical restraint with a collar or leash. This is unpleasant and potentially uncomfortable for the dog. Additionally, it also requires the owner to use one of their hands for restraint, when often two hands are needs for a quick and effective washing.

Although great strides have been made in the area of pet distraction systems and methods of use, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a system and method of the present invention in accordance with the preferred embodiment of the present invention;

FIG. 2 is a front view of the pet distraction device of the system of FIG. 1;

FIG. 3 is a simplified schematic of the pet distractive device and treat combination of the system of FIG. 1; and

FIG. 4 is a back view of the pet distraction device of the system of FIG. 1;

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional systems and methods for pet distraction devices. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

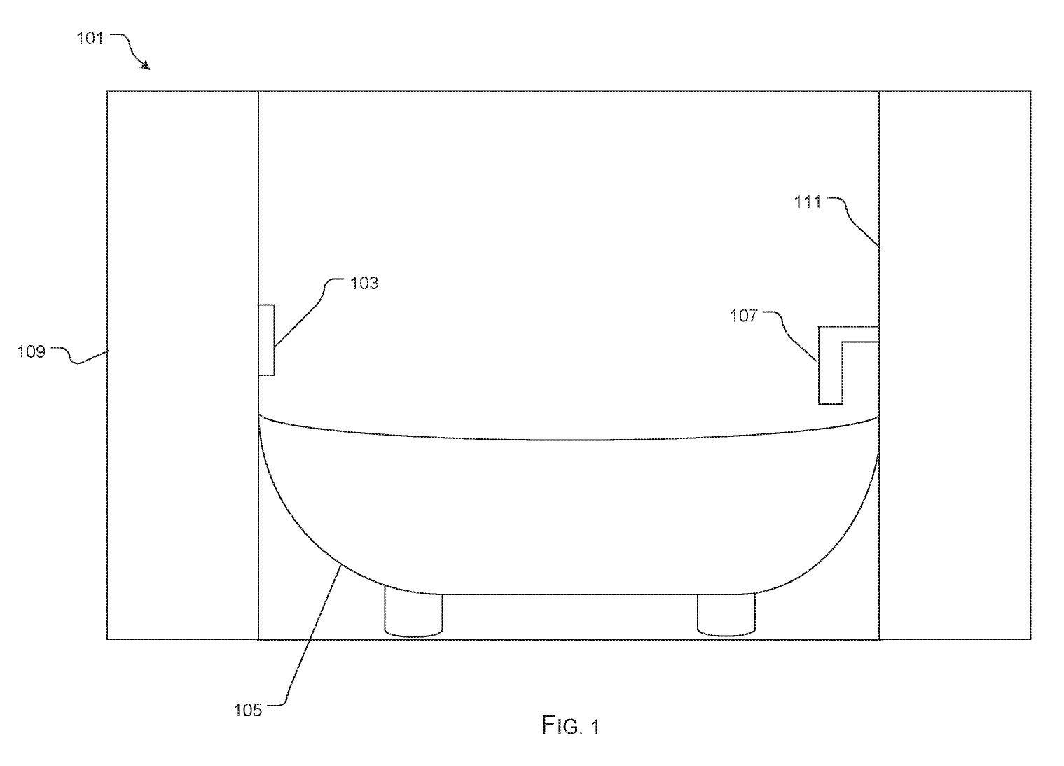

Referring now to the drawings wherein like reference characters identify corresponding or similar elements throughout the several views, FIG. 1 depicts a view of a system 101 and method of use in accordance with a preferred embodiment of the present application. It will be appreciated that system 101 overcomes one or more of the above-listed problems commonly associated with the conventional systems and methods for pet distraction devices.

In the contemplated embodiment, system 101 is contemplated utilizing a pet distraction device 103 and a spreadable, edible treat 303 configured to overcome the problems commonly associated with conventional delivering processes.

Referring now to FIG. 1, system 101 is shown as a side view of a bathroom enclosed by at least two bathroom walls 109, 111, a bathtub 105, a water faucet 107 and a pet distraction device 103 removably attached on the bathroom wall 109. It is contemplated that the pet distraction device 103 is configured to be used in conjunction with a spreadable, edible treat such as peanut butter to facilitate the pet distraction during a washing.

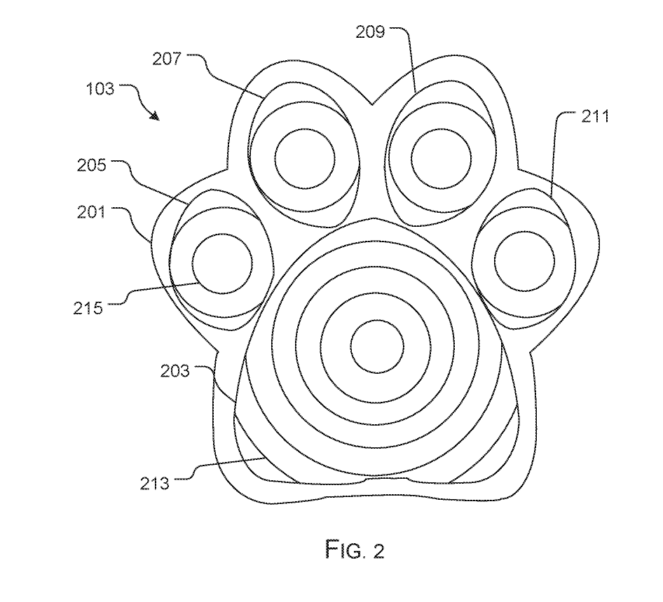

Referring now to FIG. 2, a front view of the pet distraction device 103 is shown having a novel design shape 201 with a plurality of indentations 203, 205, 207, 209, 211 with raised contour features 213, 215. In the preferred embodiment, the novel design shape 201 is configured as a dog paw with the plurality of indentations forming the metacarpal pad 203 and the four digital pads 205, 207, 209, 211. Inside each indentation, the plurality of raised contour features 213, 215 are configured as a series of concentric circles. It is contemplated that the height of the raised contour features 213, 214 does not exceed the depth of the indentations 203, 205, 207, 209, 211.

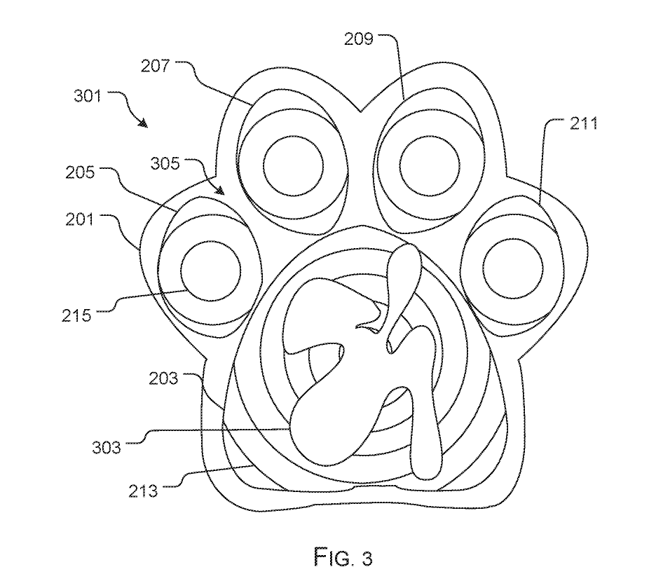

Referring now to FIG. 3, a front view of the pet distraction device and treat combination is shown as system 301. The pet distraction device 103 is shown having the same features as FIG. 2. In addition, a spreadable, edible treat 303, such as peanut butter, is shown spread onto the front surface 305. In one embodiment of the system, the treat 303 is spread into the indentation 203 and onto the contour grooves 213. The indentations and the contour grooves are configured such that the peanut butter will stay on the device as long as required and will not be removed in one lick from the pet. In an alternate embodiment, the treat 303 may be peanut butter, pet food, jam or other edible, spreadable treat or food.

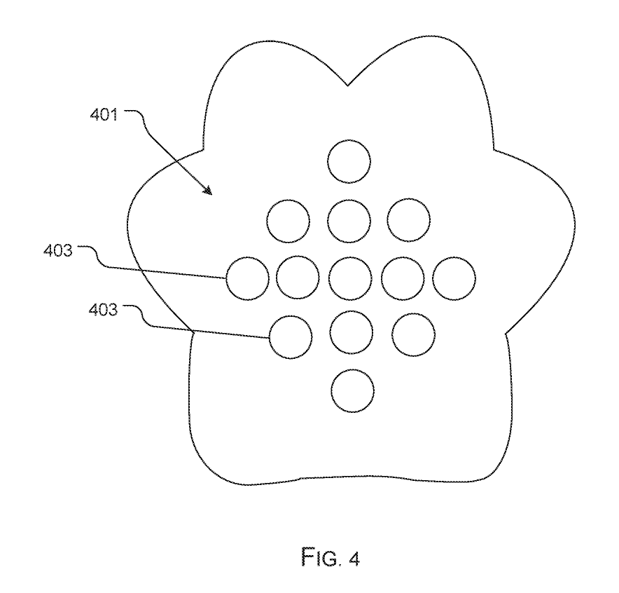

Referring now to FIG. 4, a back view of the pet distraction device 103 is shown having a back surface 401 and a plurality of suction cups 403 attached to the back surface 401 of the pet distraction device 103. The suctions cups 403 are configured such that the pet distraction device 103 may be attached to any clean, smooth surface, such as a shower wall, counter top, floors, doors, portable stands, or other surface. The surfaces may be located in bathrooms, kitchens, gardens, or other location.

In one contemplated embodiment, it is anticipated that the pet distraction device 103 may be comprised of a food-safe silicone, rubber, polyurethane, polycarbonate, metal or other suitable material. Alternatively, the device 103 may be comprised of a non-food safe material and then given a food-safe coating such as epoxy resin.

The pet distraction device 103 may be manufactured using injection molding, rotational molding, compression molding, die casting, laser cutting, 3D printing or other suitable method.

In the preferred embodiment, the novel design shape 201 is configured as a dog paw shape. In an alternate embodiment, the novel design shape 201 may be configured as a bone shape, a face shape, an animal shape or other variation.

The pet distraction device 103 may be used for dogs, cats, bird, pigs, reptiles or other animals.

The pet distraction device 103 may be used by pet owners, pet caretakers, veterinarians, dog groomers, dog trainers or other user.

In the preferred embodiment and method of use of the present invention, the pet distraction device 103 is formed of a food-safe silicon. The device has a contoured front face with several indentations. The user applies peanut butter to the front face of the device. On the rear, are a series of suction cups. These allow the device to be mounted onto a smooth surface at the level of the dog's head. The device is deployed when the user requires the dog to be still for a period of time, for example when washing the dog. The dog begins to lick the peanut butter from the front face the device, and continues to do so while being washed. The contoured and uneven surfaces ensures that some of the peanut butter remains on the surface and won't be removed by the licking action too quickly. The dog is content and remains still and distracted while the owner carries out the needed task. The device can then be removed and placed in the dishwasher to be cleaned and ready for another use.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A pet distraction device comprising:
a front surface;
a plurality of indentations located on the front surface;
a plurality of raised contour grooves located inside the indentations;
a back surface; and
one or more suction cups attached to the back surface;
wherein the front surface, back surface, and indentations form a design shape.

2. The pet distraction device of claim 1, wherein the design shape is configured as a dog paw, and the plurality of indentations further comprise:
a middle indentation configured as the shape of a metacarpal pad of the dog paw; and
four peripheral indentations configured as the shape of digital pads of the dog paw.

3. The pet distraction device of claim 1, wherein the plurality of raised contour grooves is configured as a series of concentric circles.

4. The pet distraction device of claim 1, wherein the plurality of indentations are configured to have a specific depth, and wherein the plurality of raised contour grooves are configured to have a height that does not extend past the depth of the plurality of indentations.

5. The pet distraction device of claim 1, further comprising: a food-safe silicone.

6. The pet distraction device of claim 1 is configured to be dishwasher safe.

7. A pet distraction system comprising
a pet distraction device as described in claim 1; and
a spreadable, edible pet treat,
wherein the spreadable, edible pet is spread into the indentations and onto the contour grooves of the pet distraction system.

8. A pet washing station comprising:
a bathtub;
at least one wall;
a water source; and
a pet distraction system as described in claim 7;
wherein the pet distraction device having the spreadable, edible treat is removably attached to the wall at a desired height.

9. A method for distracting a pet comprising:
providing a pet distraction device as claimed in claim 1;
removably attaching the pet distraction device in a location easily accessible by a pet;
spreading an edible treat onto the pet distraction device; and
while allowing the pet to lick the edible treat off of the pet distraction device, performing a necessary care task such as washing or a flea-treatment.
